(19) United States
(12) Patent Application Publication
(10) Pub. No.: US 2006/0089845 A1
(43) Pub. Date: Apr. 27, 2006

(54) Golf course management system

(76) Inventors: Brian Marcell, Desboro (CA); Gregory Brian Milburn, Chatsworth (CA); Ryan William Somerville, Owen Sound (CA); George Erian, Owen Sound (CA); Monsoor Shaik, Barrie (CA); James Henderson, Mitchell (CA)

Correspondence Address: HARNESS, DICKEY, & PIERCE, P.L.C, 7700 BONHOMME, STE 400, ST. LOUIS, MO, 63105, US

(21) Appl. No.: 10/974,465

(22) Filed: Oct. 27, 2004

(51) Int. Cl. G06Q 99/00

(52) U.S. Cl. 705/1

(57) ABSTRACT

A golf course management system has an administration manager for managing administrative information including member information, a golf service manager for managing golf services using the member information; an auxiliary service manager for managing auxiliary services, the auxiliary service manager being linked with the golf service manager to handle golf services and auxiliary services together; and a system manager for managing the golf course management system using information obtained from the administration manager, golf service manager and the auxiliary service manager.

The present invention relates generally to a system for golf course management, and more particularly to a system for a golf course management system that allows integrated management of a golf course.

### BACKGROUND OF THE INVENTION

Golf course companies need to manage several aspects of their businesses, such as course booking, product sales, food services and equipment inventory. Typically golf course companies use different systems for different aspects of their business. While there are variety of aspects, they are often related to each other. Different systems often require redundant work to enter and maintain information which has been already entered or updated in a different system. If the company wants to provide a new service to its members, a new system needs to be introduced and the information of members needs to be entered in the new system. Also, having different systems makes difficult to obtain an overview of the business. Further, traditional systems for golf course management are not customizable or offer limited customizability sand do not offer real-time online tee sheet booking in the industry.

Accordingly, it is desirable to provide a mechanism that allows a golf course company to manage several aspects of its golf course interactively in an organized manner.

### SUMMARY OF THE INVENTION

The present invention uses a golf course management system that integrates various aspects of golf course management, and interrelate information obtained from multiple modules associated with the various aspects of golf course management.

In accordance with an aspect of the invention, there is provided a golf course management system comprising an administration manager for managing administrative information including member information; a golf service manager for managing golf services using the member information; an auxiliary service manager for managing auxiliary services, the auxiliary service manager being linked with the golf service manager to handle golf services and auxiliary services together; and a system manager for managing the golf course management system using information obtained from the administration manager, golf service manager and the auxiliary service manager.

In accordance with another aspect of the invention, there is provided a method of handling golf course related information, the method comprising the steps of: gathering and storing using an administration manager administrative information including member information; providing golf services using a golf service manager based on the member information; providing auxiliary services using an auxiliary service manager by linking with the golf service manager to handle golf services and auxiliary services together; and interrelating information obtained from the administration manager, golf service manager and the auxiliary service manager.

In accordance with another aspect of the invention, there is provided a computer readable memory having recorded thereon statements and instructions for execution by a computer to carry out the method of handling golf course related information, the method comprising the steps of: gathering and storing using an administration manager administrative information including member information; providing golf services using a golf service manager based on the member information; providing auxiliary services using an auxiliary service manager by linking with the golf service manager to handle golf services and auxiliary services together; and interrelating information obtained from the administration manager, golf service manager and the auxiliary service manager.

In accordance with another aspect of the invention, there is provided a carrier wave embodying a computer data signal representing sequences of statements and instructions which, when executed by a processor cause the processor to handle golf course related information, the statements and instructions comprising the steps of gathering and storing using an administration manager administrative information including member information; providing golf services using a golf service manager based on the member information; providing auxiliary services using an auxiliary service manager by linking with the golf service manager to handle golf services and auxiliary services together; and interrelating information obtained from the administration manager, golf service manager and the auxiliary service manager.

### BRIEF DESCRIPTION OF THE DRAWINGS

Embodiments of the invention will now be described by way of example only with reference to the following drawings in which:

FIG. 1 is a block diagram showing a golf course management system in accordance with an embodiment of the invention;

FIG. 2 is a block diagram showing an embodiment of the golf course management system;

FIG. 3 is a block diagram showing an embodiment of an administration manager;

FIG. 4 is a block diagram showing an embodiment of a record handler;

FIG. 5 is a block diagram showing an embodiment of a golf service manager;

FIG. 6 is a block diagram showing an embodiment of an auxiliary service manager;

FIG. 7 is a block diagram showing a system manager;

FIG. 8 is a diagram showing an example of a screen display; and

FIG. 9 is a diagram showing another embodiment of a golf course management system.

### DETAILED DESCRIPTION OF THE PREFERRED EMBODIMENT

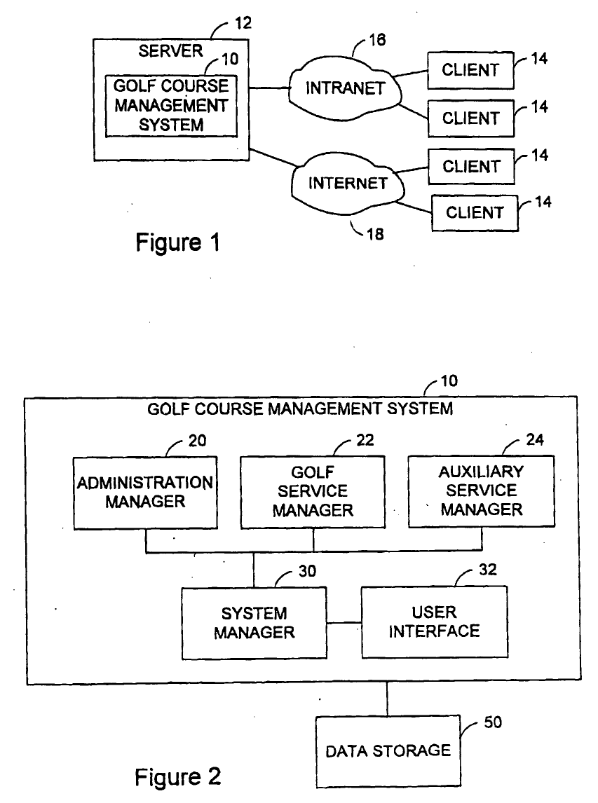

Referring to FIGS. 1 and 2, a golf course management system 10 in accordance with an embodiment of the present invention is described. The golf course management system 10 is suitably implemented in a server system 12 of a golf course company, and used from multiple clients 14 through a communication network, such as intranet 16 of the golf course company and/or Internet 18. Clients 14 may be computers of managers of the company, computers at the reception of the course, point of sale (POS) system devices, and/or computers of customers. Clients 14 may suitably use web browser to access the golf course management system 10.

As shown in FIG. 2, the golf course management system 10 has an administration manager 20, a golf service course manager 22, auxiliary service manager 24, system manager 30 and a user interface 32. The administration manager 20 assists the user to manage administrative information, such as a member list, employees list, product inventory and/or equipment inventory. The golf service manager 22 assists the user to manage the golf services, such as golf course scheduling, tee sheet services, handicap calculation and/or score keeping. The auxiliary service manager 24 allows the user to manage other customer services, such as food services and product sales services. The system manager 30 assists users to control access to various functions of the golf course management system 10 by users through the user interface 32, generate reports, work order and/or purchase orders, and/or manage marketing. The information gathered by the managers 20-24 are stored in a data storage 50. The data storage 50 may be provided as part of the golf course management system 10 or as a separate device.

The golf service manager 22 uses information from the administration manager 20, such as members' information, and link to auxiliary service manager 24 for providing auxiliary services, such as food services, while providing golf services. The system manager 30 uses information gathered by the managers 20-24 to generate reports and orders. The golf course management system 10 allows these managers 20-30 to share the information.

Through the golf service manager 22, the golf course management system 10 provides a management mechanism specific to the golf course management business. By sharing the information among the different managers 20-30, the golf course management system 10 provides an integrated system that allows management of the golf course in an organized manner. Thus, the golf company users can use a common system to manage and analyse its business while providing golf services and auxiliary services to customers efficiently using the golf course management system 10

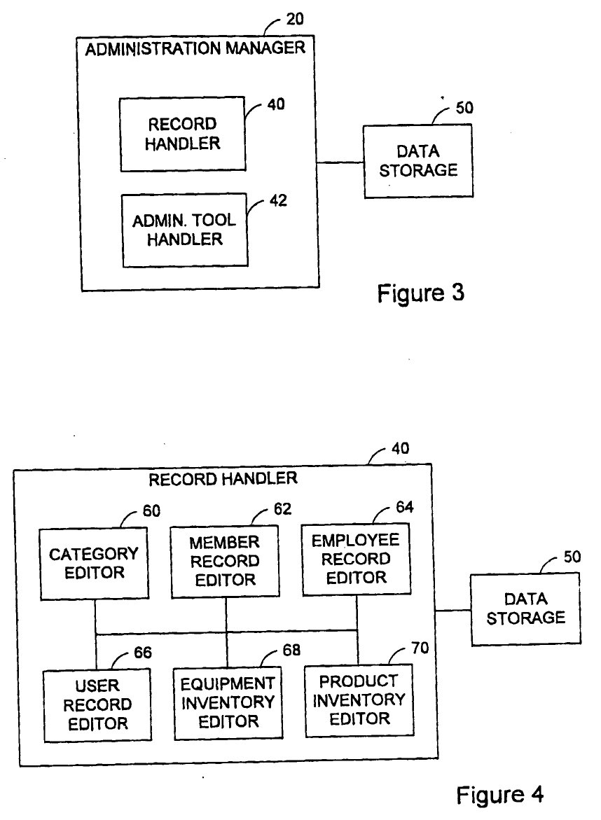

FIG. 3 shows an embodiment of the administration manager 12. It has a record handler 40 and administration tool handler 42.

The record handler 40 handles various records relating to the golf course business, such as lists of customers, members, employees, users, vendors, equipments and/or products. The record handler 40 stores information in the data storage 50.

FIG. 4 shows an example of the record handler 40 having a category editor 60 and record editors 62-70 for various categories. The category editor 60 allows the user to manage categories of records. In this example, there are five categories: member record, employee record, user record, equipment inventory and product inventory. The record editors 60-70 allow the user to edit the record in each category. Other embodiments of the invention may have more or fewer categories.

For example, when the user, through the user interface 32, selects to edit records, the record handler 40 is activated. The category editor 60 of the record handler 40 prompts the user to select a category that the user wants to edit. When the user selects a category, its associated record editor 62 -70 is activated and prompts the user to edit the record. If it is a new category, the user selects to add a new category and enters information of the new category. The category editor 60 creates a new category based on the information entered. The record handler 40 provides an associated record editor.

For example, when the user selects a category “Member”, the member record editor 62 presents a list of existing members, and prompts the user to select an existing record in the member list or add a new member to the members list. When the user selects to add a new member, the member record editor 62 provides a member add screen to prompt the user to enter information of the new member. When the user selects to edit the record of a particular member, the member record editor 62 retrieves the record of the particular member from the data storage 50, and provides a member record screen with the current records of the particular member to allow the user to edit the record. Once the addition and/or edit of the member list is finished and the user commands to save the record, the member record editor 62 updates the records in the data storage 50.

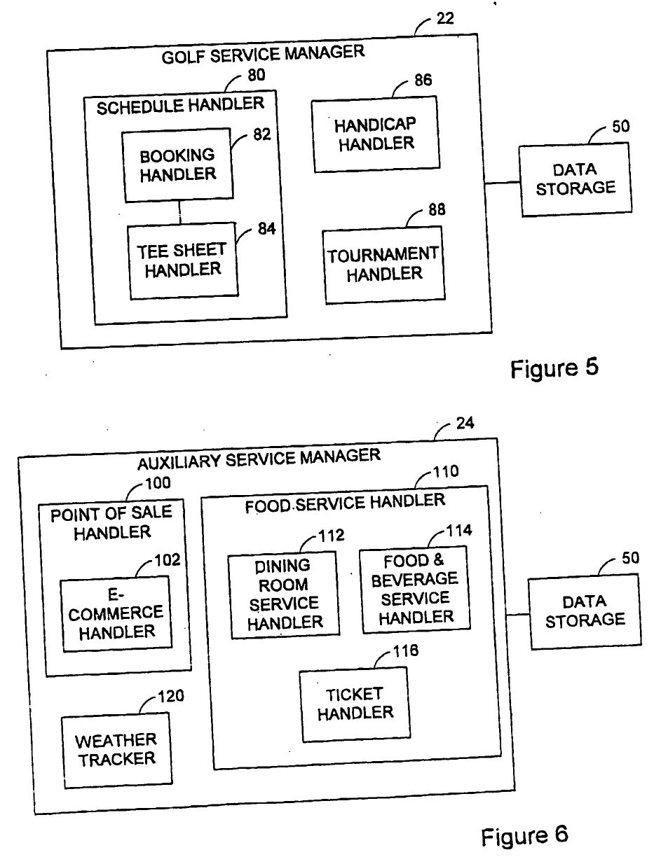

The user can activate the member within a handicap handler 86 (FIG. 5), as described below. To this end, the user can also assign a unique username and password for the member. The member record editor 62 stores the username and password in the member record with other information.

Similarly, the user can add and/or edit employee records and user records using the employee record editor 64 and the user record editor 66. For employees, required information at the time of initial data entry may include the first and last name and start date of a new employee. The employee record editor 64 may allow other information to be entered at a later time.

The user record editor 66 is used to provide authorization to allow selected employees to access selected functions in the golf course management system 10, such as part or full functions of the administration manager 20, course manager 22, service manager 24 and/or the purchase order manager 26 as described below. To this end, user records may include user ID, password and an optional note.

The equipment inventory editor 68 assists the user to perform equipment inventory. The desired information for equipment inventory may include equipment names, types, locations and dates. The equipment inventory editor 68 may store inventory information by categorizing equipment.

The product inventory editor 70 assists the user to perform product inventory for products that the golf course company sells. The desired information for product inventory may include, product inventory item categories, item information, such as names, and types, item account numbers and prices. The item categories may have main categories and subcategories. It may also include a tax information for the accounting purposes. It may also include indications or flags for those products that are used to calculate green fee rates or cart fees, or if the item is to be displayed within an onscreen menu in the food & beverage service handler 114 (FIG. 6), as described below.

The product inventory editor 70 assigns an item account number to each inventory item according to the user's input or according to a system default, e.g., assigning a next available number in the selected category. Item account numbers may be assigned such that account numbers allow break down of sales into categories, such as total dollar amount for green fees sold, and total dollar amount for clothing sold. It is desirable that the categories match those used by the accountant of the golf courses company. In order for the user to assign appropriate product inventory item account numbers, the product inventory editor 70 may present to a user a list of item account numbers that are being used, and allow the user to add/edit account numbers from the list.

When a product item is to be displayed within an onscreen menu in the food & beverage service handler 114 (FIG. 6), the product inventory editor 70 stores the information of the product item with information about its associated menu category and subcategory, if any, which is linked to the menu category. The food & beverage service handler 114 uses the associated menu category and subcategory to define where the product item is displayed within the food & beverage onscreen menu, as described below.

The product inventory editor 70 may use an item reading system, such as a barcode system. In that case, the product inventory editor 70 allows the user to create barcodes for product items, and print barcode labels.

The product inventory system allows for each inventory item to be associated with up to 4 different charts of account numbers. Additionally the system allows for the distribution amount to be customized. This allows for proper accounting of combination or packaged products. For example, if the golf course chooses to have “9 and dine” combo item allowing for golf and dinner at one fixed price the system will allow for the pro shop chart of accounts to be accurately tracked and the Food and Beverage chart of accounts to also be accurately tracked.

The current golf course management system can be accessed using Biometrics and has an integrated time clock. This allows validation of, for example, an employee working (start time and end time) and that they were the person who entered a transaction into the POS system. Traditional POS systems used ID codes i.e. 23. Often these codes (passwords) are posted near or on the POS system therefore making them completely ineffective in tracking employee actions with respect to sales or other mission critical system changes and activities.

The golf course management system of an embodiment of the current invention offers seamless integration of all areas of the golf course. Many golf courses have many non-integrated software systems. The use of many non-integrated systems inevitably results in redundant work being performed in all areas of the facility. The areas of frequent software fragmentation include but are not limited to Pro Shop, Food Services, Grounds Maintenance, Web Sites, E-commerce, Web Bookings, Email Marketing, etc. A non-integrated systems allows a customer to be known by the pro shop but not recognized by the food and beverage, web booking. The system allows by adding a customer in one area all other areas have access to the same information.

The system of the an embodiment of the current invention provides assistance in the management of the following areas: POS, Tee Sheet, Food and Beverage, Dining Room Reservations, Golf Simulator Reservations, Cottage Reservations, Employees Handler, Employee Scheduling, Equipment Inventory Control, Product Inventory Control, Tournament Contracts, Event Planning and Contracts, Administration of Members and Customers, Purchase Orders, Work Orders, Vendors, User Access Controls, Handicap System, E-Flyer Marketing, Reporting on all aspects of the facility and, Tournament Manager Tool.

The POS system according to an embodiment of the invention operates on a Microsoft Mobile Windows™ platform found on many of today's PDA's. This POS system has been developed with the intention to allow Food and Beverage servers to create orders real-time at the table with the customer and send these orders directly to the kitchen. This system prevents redundant double work by the servers. Additionally the time lost getting the order to the kitchen staff is reduced allowing customer to get their order faster.

The administration tool handler 42 may include a tool for backing up the data in the data storage 50 and other data for the golf course management system 10.

The administration tool handler 42 includes an employee scheduler allowing for all staff at the facility to be scheduled for their job function, location and department. The employee scheduler allows for staff to be easily scheduled for 7 day periods at a time. Additionally the employee scheduler allows for rates to be assigned to each employee based on their job function. This allows the employee scheduler to track scheduled hours as they relate to predetermined budgets. Employee wages are normally not tracked very well and overages are often realized after the month is over and it is too late fix the blown budget. The scheduler in combination with the Biometric time clock handler allows for the reporting of budgeted, scheduled, and actual year to date and month to date figures to be reported.

FIG. 5 shows an embodiment of the golf service manager 22. The golf service manager has a schedule handler 80, handicap handler 86 and tournament handler 88.

The schedule handler 80 has a booking handler 82 and tee sheet handler 84. The booking handler 82 handles booking of a tee time, and the tee sheet handler 84 handles the scheduling of tee times.

The booking handler 82 provides a tee sheet booking page. The booking page may be accessed by users within the golf course company through the intranet 16, or by customers of the golf course through the Internet 18. The booking handler 82 prompts the user to fill out the blanks of the booking page for booking information, such as the names of players, the starting tee time and date, and the length of play. The information may also include its crossover tee time, which allows attendants to control the pace of play of the group's crossover. The attendants can move it to speed up/slow down the pace of play as needed. This control over the pace of play is accomplished by selecting a later crossover time from a drop down list at the time of booking the tee time. Additionally, the golf course can choose to set the crossover time required in the administration area thus allowing for customization for the course.

The booking handler 82 may use information of members from the record handler 40. For example, when the user or customer enters a member ID, the booking handler 82 obtains the information associated to the member ID from the record handler 40, and automatically fills out some blanks in the booking page based on the information.

The booking handler 82 may also allow booking of carts, and ordering food, beverage or dining. Additionally the booking handler 82 allows for the booking of rental equipment including but not limited to pull carts, clubs and shoes.

Once the user or customer finishes the data entry and commits the booking, the booking handler 82 saves the information on a relevant tee sheet. Also, the booking handler 82 sends a food order to the food service handler 110 (FIG. 6).

Each tee time can only be booked by one party making double booking impossible. The system allows all bookings by default. The system provides the flexibility to restrict bookings based on information collection, membership and other types of customer status. Bookings that have been rejected after a successful booking has occurred are deleted by all users.

The tee sheet handler 84 provides electronic tee sheets that show information of the tee scheduling at glance. The tee sheet handler 84 typically shows a tee sheet for a day in a single window and allows to select a particular day to view. It may show multiple tee sheets at once or use a different format, or allow the user to select different views. The tee sheet handler dynamically links to member and customer information. This information is displayed to the user using colour coding for member type. The golf course can choose to have VIP members in blue to ensure attendants are aware of their status an that they receive VIP service. The colour coding of the member name is different from the colour coding used for displaying payment information as described later in this document. Additionally the Tee Sheet handler allows for other historic information to be displayed to the user. Information contained within the member and customer database is presented simply by moving the mouse over a member name on the tee sheet. Information currently displayed includes: number of golf reservations, number of cancelled reservations, number of completed rounds of golf, number of no shows, full name, photo, credit card information, locker number, member type, etc.

The tee sheet handler 84 receiving booking information from the booking handler 82, and customers the information of players who have booked a tee time. A receptionist or attendant of the golf course can use the tee sheet to check in the customers. Alternately upon paying for golf the golfers who have paid their dues are automatically checked in on the tee sheet.

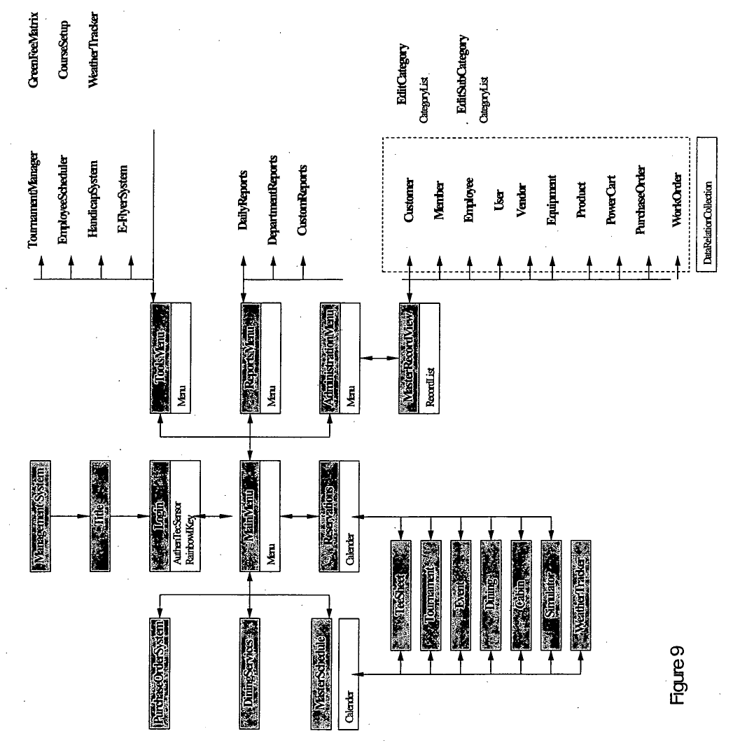

FIG. 8 shows an example of a partial view of a tee sheet. It shows time, action, players, length of play, and the usage of power carts.

The tee sheet has a Cart Availability function which works in the background calculating the number of carts which can be booked at any given tee time based on what the bookings look like 5 hours in the past and 5 hours in the future. This process ensures that the attendant knows with out a doubt on Tuesday that the customer on the phone booking for Saturday will be able to have two power carts at 3 pm. This function takes into account the number of available power carts, length of bookings within the active range, and other golf cart bookings. The system will stop the attendant from booking power carts if that will result in a domino effect causing a shortage of power carts for other reservations hours after the current booking.

The tee sheet handler 84 may obtain payment information from a point of sale handler 100 (FIG. 6), and shows the status of the players in the tee sheet.

The tee sheet handler 84 may use a colour coding system to indicate the status of the players. For example, during a tee time, each player may be shown in four colours: the first colour showing that the player is playing; the second colour showing that the player has checked in and is ready to play, the third colour showing that the player has paid, and the fourth colour showing that the player has not paid. The colour cording may be used in a combination, such as the player name in the first colour with an underline in the fourth colour, which means that the player is playing but has not paid.

The tee sheet handler 84 may show the status of each player using a pop-up window which pops up when a cursor is brought on player's name. The pop-up window status displaying may be used alone or together with the colour coding system.

The tee sheet handler 84 allows rescheduling of tee times by copying the current tee time booking information to a desired time. Also, it provides a function to book multiple tee times for a same player or a same group by copying the information to desired multiple tee times.

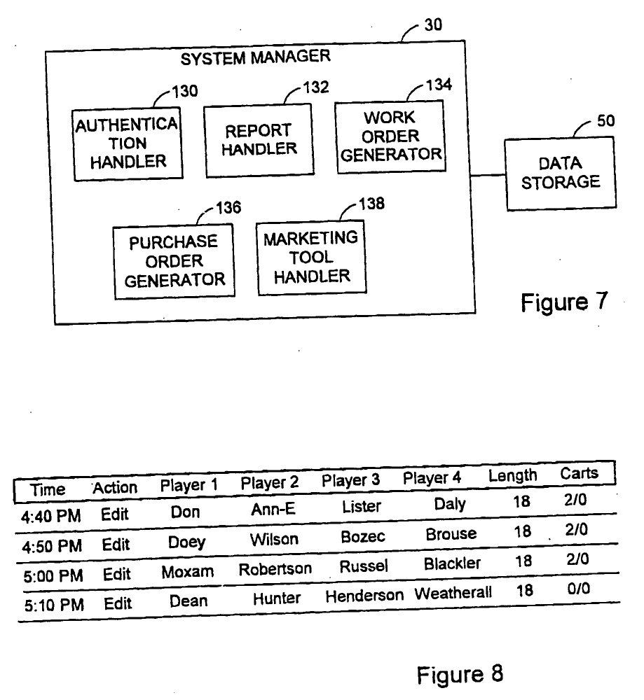

The handicap handler 86 provides a handicap and score keeping system that allows the user to calculate his/her handicap and keep scores. The handicap and score keeping system is typically used by a registered member who has been given a username and password. When the member enters the user name and password to log into the handicap system, the authentication handler 130 (FIG. 7) obtains the information of the member from the record handler 40 using the username, and checks the password matching to determine if the member has authorization to access the handicap and score keeping system of the handicap handler 86.

Once a member logs into the handicap and score keeping system, the handicap handler 86 prompts the member to enter the information of the play, such as the course, tees, date played, round played and score. The handicap handler 86 may obtain information of the courses that the member played from the schedule handler 80, and present it to the users for selection. When the user submits desired information, the handicap handler 86 stores the information for the member in the data storage 50.

The handicap handler 86 may also prompt the member to optionally enter the score per hole.

The handicap handler 86 may also provide an import function to import information of a different course.

The handicap handler 86 is connected to the member and customer database allowing for the member information to be linked to the handicap system again not requiring the member or customer to enter the same information repeatedly around the golf course.

The Handicap system contains a database of slope ratings as provided by, for example, the GAO (Golf Association of Ontario). This database allows users of the Handicap System of an embodiment of the current invention to enter handicap scores for their home course or any other course in Ontario. By default the home course would be selected however this does not preclude the user from entering scores from rounds of golf played at other facilities. The database, which is updated annually, allows for this functionality. The system has a utility to extract the raw data from the provided database and import it into the database of an embodiment of the current invention.

The Tournament Manager provides golf courses with the ability to manage all aspects of golf tournaments. For many golf courses tournaments represent a large source of revenue and often require a dedicated staff member to coordinate all aspects of tournaments at the course. The system of an embodiment of the current invention allows all involved in the facility real-time access to the same pool of data. Tournaments generally have several fundamental parts, which are all represented in the tournament manager system of an embodiment of the current invention.

The system provides a quick tournament tee sheet blocker and adder. This is a quick tool allowing golf course administration to quickly add a tournament to the schedule and to block off the appropriate tee times on the tee sheet. At this time basic information is collected about the tournament including name, description, date, duration, organizer, etc. The next step is the Tournament Contract. This is a document that has been compiled from the tournament contracts of many golf courses. The contract of the system is dynamic in calculating all prices for the various cost centres of the tournament.

Tournaments generally have golf and food and beverage aspects. The first is golf. Under this heading the system allows for all types of play to be managed, contests to be organized, power carts to be reserved, etc. Under Food and beverage the system allows for dining room reservations to be made, menus to be selected for breakfast, lunch, dinner, appetizers, desserts, etc. Form this portion of the form DJ, prize tables, etc. can be managed. Once the tournament contract has been completed all parties involved can sign off on the details and a deposit is generally received. The next step in the process is managing the tournament it self. The system allows for tournament participants to be added to the tournament. Once all participants have been added Tee off pairings can be done in a number of styles depending on the needs of the tournament organizers. After this is completed Power Cart Signs can be generated and printed. The system also allows for the tournament to be scored and winners of various events tracked. This helps to prevent human error.

FIG. 6 shows an embodiment of the auxiliary service manager 24. The auxiliary service manager 24 has a point of sale handler 100 and a food service handler 110.

The point of sale (POS) handler 100 handles sales information at each point of sale of the golf course company. It has an e-commerce handler 102 to handle sales information through e-commerce.

The POS handler 100 may obtain information of product items on sale from the product inventory editor 70 of the record handler 40, and present a list of the items for selection by the user at a POS system device. The POS handler 100 may receive item information including an inventory ID from a tag reader, such as a barcode scanner, of a POS system device. The POS handler 100 prompts the user to enter the total and a method of payment. The POS handler 100 stores the sale information in the data storage 50, and sends the information to the product inventory editor 70 for update.

The food service handler 110 has a dining room service handler 112, a food & beverage service handler 114 and a ticket handler 116.

The dining room service handler 112 assists the user to schedule and arrange seating of customers. The user in this case is typically an attendant of the dining room. The dining room service handler 112 presents a dining room layout screen for the seating arrangement. The dining room handler 112 prompts the user to locate the customers to a table on the screen, and enter the number of customers at the table. The dining room handler 112 may also presents a list of employees and allow the user to select his/her name to be assigned to the table.

Once the table is assigned, the dining room handler 112 may activate the food & beverage service handler 114 for ordering food and beverage.

The dining room handler 112 may present the user an overview of the table assignment and ordered food and beverage. The dining room handler 112 may send the order to the POS handler 100 for displaying or printing out at the kitchen.

The dining room handler 112 allows the user to change and update the sheeting and orders using the dining room overview.

The dining room handler 112 may present the overview of the dining room using a colour coding system to show the status of tables in different colours.

The food & beverage service handler 114 assists ordering of food and beverage. It presents a menu for selection at a POS system unit located in, e.g., a bar or dining room. The food & beverage service handler 114 sends the orders to the POS handler 100. The food & beverage service handler 114 may be linked from the booking handler 82 so that the user can order food and beverage at the time of booking a tee time. Also, the food & beverage service handler 114 may be linked from the dining room service handler 112 as described above.

The ticket handler 118 handles issuances of tickets for food sale through a POS system unit located at, e.g., a bar or dining room. The ticket handler 118 obtains information, such as a server name, order number, table number, number of guests, items ordered, and the total of fees, from the dining room service handler 112 and/or food & beverage service handler 114. The ticket handler 118 issues a ticket including the information. The ticket handler 118 may provide options of splitting the amount or combining with other tables' amounts.

The ticket handler 118 typically first issues a bill. Once the user receive payment and the bill is settled, the user enters the settlement information in the POS system unit which sends the settlement information to the ticket handle 118 and issues a final receipt. The ticket handler 118 sends the settlement information to the POS handler 100. The POS handler 100 sends the information to the product inventory editor 70.

The auxiliary service manager 24 may also have a weather tracker 120 to provide weather information to the users through, e.g. the booking handler 82 or tee sheet handler 84.

The Weather Tracker is a tool used by the Golf Course General Manager and Grounds Keeper Manager to analyze the impact of weather on two important aspects of the golf course. Firstly, the General Manager is interested in comparing historic revenues to current revenues. General Managers realize that forecasted and actual weather have a huge impact on golf. If the forecast is for rain golfers will plan on other activities for the weekend. The forecasted weather can have a greater impact on play than the actual weather on any given day. Many if not all golf courses have link to a web based weather service which tells the website user the forecast and current conditions. While this information is useful it is always too general to be of value to the General Manager and Grounds Keeper Manager. Users want to track their own weather findings.

FIG. 7 shows an embodiment of the system manager 30. The system manager 30 has an authentication handler 130, report handler 132, work order generator 134, purchase order generator 136 and marketing tool handler 138.

The authentication handler 130 checks authentication of users who attempt to access to functions of the golf course management system 10. It uses the information, such as user name and password, stored in the data storage 50 through the member record editor 62.

The report handler 132 allows the user to produce reports, such as reports on daily sales, sales summary by station report, sales summary by user and detailed sale summary for all transactions. The report handler 132 obtains information that are used to generate reports from the administration manager 20, golf service manager 22 and auxiliary service manager 24.

The report handler 132 provides the user with options of several preformed reports. The options may be provided in several layers. For example, the options in the first layer may include daily sales, monthly sales, or yearly sales reports. When the user selects daily sales reports, the second layer of options appear, which may include daily sales by station, daily sales by user, and daily sales for all transactions. When the user selects the daily sales reports by user, the report handler 132 provides a list of users. When the user selects a particular user and date, the report handler 132 obtains relevant sale information from the POS handler 102, and generates a report of daily sales summary for the selected user.

The report handler 132 may present reports by showing total debits and credits for the daily sales. The user can use this report to ensure completion of all transactions of the day correctly by checking each total shown for cash, credit cards and debit cards. The report handler 132 may also present reports that show the tax breakouts.

The report handler 132 provides a link in the report to the POS handler to view details of transactions for determining errors. The detail view may present each transaction information that has been entered by the user, such as the date/time, transaction ID number, the station where the user entered the transaction, each item rung in, the price, the subtotal, taxes, method of payment, and the change back. The report handler 132 may allow selected users to make correction to the data.

Similarly, the report handler 132 may generate a daily sales summary by station report which shows a total of all sales rung in under a selected station, a daily sales summary for all transaction report that shows the report for any transaction entered by every user on every station.

The report handler 132 may have a function to reproduce a receipt for a selected transaction.

The work order generator 134 generates a work order using the information from the schedule handler 80 and the record handler 40. As often over half of a golf courses expenses related to maintenance of the course. The greens maintenance portion of a golf course often represents the majority of the employees and the majority of all expenses. The system allows management to track, evaluate and therefore effectively manage this side of their business. The work order system allows for work orders to be created for all aspects of the golf course. An example of a work order may be for an employee to cut the 18 fairway. This task can be given to a particular employee and their time tracked. Over time the management will be able to know that someone working hard will be able to cut the 18 fairway in 3 hours. The next time someone takes 6 the management will know that they were slacking off. Due to the size of golf courses it is important to be able to track employee time for cost savings, accountability and possible bonuses. Additionally, by knowing the square footage of the same 18 fairway a golf course can know that they spread 20 kilos of fertilizer. Over the course of the season this allows the maintenance manager to generate reports to ensure that they are adequately fertilizing the grass and ensure that they are in compliance with strict environmental legislations preventing over watering, too much fertilizer, and too much use of pesticides.

The purchase order generator 136 generates a purchase order based on the information of the product inventory from the record handler 40 and sales information from the POS handler 100.

The marketing tool handler 138 allows golf courses to send e-marketing materials and other information postings to their membership by way of formatted html email. The eflyer system of an embodiment of the invention allows golf courses to easily send email to segments of or all of their membership and/or customers. The system provides for interaction of the website and the golf courses customer and membership database allowing users of the system to send messages to all or part of their membership. Real-time database connectivity is used creating accurate information reporting.

The marketing tool (e-Flyer) allows golf courses to target market their members and customers with email marketing. These lists can be created by analyzing purchasing behaviour in the pro shop, dining room, and or golfing preferences. For example, the golf course may want to drive more weekday business. To accomplish this they send out an eflyer to all customers who have never golfed during the week. The course may choose to offer discounts or free meals in an attempt to have more weekend golfers golf during the week.

The system provides the ability to associate each transaction and tee time with a particular member or customer. This interaction between the membership and customer databases with the Tee Sheet and POS allows for reports to be generated based on activity per customer or member. Members can charge their purchases at the golf course to their member account. In most situations these charges are manually added at the end of each month and manual invoices are sent out to the membership. This process is needlessly time consuming. The system links the membership database and the POS to automatically generate Monthly Member Account Statements for all members. The golf course can easily manage their membership charging and collection of items charged to account. The system provides the course and member with a summary of all charges incurred during the report time frame as well as complete disclosure of each transaction comprising the total amount owing. Thus providing the member and course with all of the information that they require to either pay or collect payment.

FIG. 9 shows a golf course management system in accordance with another embodiment. Various modules are interrelated to allow sharing of the information obtained during the operation of the modules.

The Dinning Room Reservation Handler allows attendants to reserve customers for dinning in the golf course restaurant. This module allows for reservation name, date, time and number in party thereby digitizing information found in current paper systems.

The Golf Simulator Reservation Handler allows for the control and booking of golf simulators. This system is flexible allowing for an unlimited number of golf simulators to be controlled. This handler is similar to the tee sheet except that the bookings are based on time and are flexible based on the wishes of the booking party. The reservations appear in a tee sheet style listing for each simulator. When payment is being sought the simulator can transfer the hourly charges to the POS. This internal link in the software allows for the simulators to then be charged to accounts and the purchase to be tracked with a particular customer or member.

The Cottage Reservation Handler allows attendants to reserve an unlimited number of cottages associated with the golf course. This module allows for reservation date, name of reservation, number in group and duration of stay.

The Tennis Reservation Handler allows for an unlimited number of tennis courts to be booked from one tool. The tennis reservation tool allows for reservation name, date, time and duration of play.

The Golf Lesson Handler allows for an unlimited number of golf professionals to control and track their bookings. This module allows for reservation date, name, lesson type, and duration. The booked lessons are visible in a tee sheet style interface.

The Event Contract Handler allows for events at the golf course to be centrally managed in one location. This system replaces the paper or database based systems which are not searchable, dynamic or visible to all employees of the golf course. This module tracks information about the booking party (contact information), date, time, organizer, Food and Beverage requirements and other auxiliary golf course services. There are also Wedding and Meeting Contract Handlers providing slightly modified Event Contract functionality.

The Tournament Contract Handler allows for all details of a tournament to be centrally managed and distributed to all staff in the golf course. This contract contains information about the golf aspects of the tournament, Food and Beverage requirements, organizer and other auxiliary golf course services.

The system is able to generate all of the golf industry benchmarks used by the KPMG™ Golf Course Consulting group. These are a set of standards of performance used to evaluate all aspects of golf course operations. The system can generate these stats given any date range through out the year or can evaluate these stats from year to year.

All of the event contracts are centrally linked to an info board. This is a dynamic database driven calendar and information reporting tool in which all tournaments, events, weddings, meetings, etc. can be view by all staff. This is use by all to be able to anticipate work load requirements for scheduling staff and when additional product must be ordered. For example, the kitchen knows that on Thursday they need 500 Chicken Breasts for a dinner at 6 pm.

The golf course management system of the present invention may be implemented by any hardware, software or a combination of hardware and software having the above described functions. The software code, either in its entirety or a part thereof, may be stored in a computer readable medium. Further, a computer data signal representing the software code which may be embedded in a carrier wave may be transmitted via a communication network. Such a computer readable medium and, a computer data signal and carrier wave are also within the scope of the present invention, as well as the hardware, software and the combination thereof.

While particular embodiments of the present invention have been shown and described, changes and modifications may be made to such embodiments without departing from the true scope of the invention. For example, the elements of the golf course management system are described separately, however, two or more elements may be provided as a single element, or one or more elements may be shared with other component in the computer system.

What is claimed is:

1. A golf course management system comprising:
an administration manager for managing administrative information including member information;
a golf service manager for managing golf services using the member information;
an auxiliary service manager for managing auxiliary services, the auxiliary service manager being linked with the golf service manager to handle golf services and auxiliary services together; and
a system manager for managing the golf course management system using information obtained from the administration manager, golf service manager and the auxiliary service manager.

2. The golf course management system as claimed in claim 1 further comprising:
a data storage for storing the administrative information.

3. The golf course management system as claimed in claim 1, wherein the administration manager comprises a record handler for handling records including lists of customers, members, employees, users, vendors, equipments and/or products.

4. The golf course management system as claimed in claim 1, wherein the record handler comprises:
a category editor for allowing the user to manage categories of records; and
one or more record editors, each associated with a category of records, the record editors allowing the user to edit the record in each category.

5. The golf course management system as claimed in claim 1, wherein
the record editors include a member record editor that allows the user to assign a unique username and password for a member for activation of a service provided to the member.

6. The golf course management system as claimed in claim 1, wherein
the record editors include a product inventory editor for assisting the user to perform product inventory for products, the product inventory editor providing indications for products to be used by the golf service manager, the auxiliary service manager and the system manger.

7. The golf course management system as claimed in claim 1, wherein the golf service manager comprises a schedule handler for handling tee scheduling using the information from the administration manager.

8. The golf course management system as claimed in claim 7, wherein the schedule handler provides an electronic tee sheet for tee time scheduling for players and showing the status of the players.

9. The golf course management system as claimed in claim 8, wherein the schedule handler links to services provided by the auxiliary service manager.

10. The golf course management system as claimed in claim 9, wherein the auxiliary service manager includes a food service handler for handling booking of food related services.

11. The golf course management system as claimed in claim 1, wherein the golf service manager comprises a handicap handler for handling handicaps of members, the handicap handler uses the information from the administration manager for handling access by the members.

12. The golf course management system as claimed in claim 1, wherein the auxiliary service manager comprises:
a food service handler for handling food related services; and
a point of sales handler for handling sales information;
wherein the auxiliary service manager communicate with the administration manager and the system manager for tracking information of food related services and sales information in relation to the administrative information.

13. The golf course management system as claimed in claim 1, wherein the system manager comprises a report handler for generating reports based on the information from the administration manager, the golf service manager and the auxiliary service manager.

14. The golf course management system as claimed in claim 1, wherein the system manager comprises an authentication handler for handling authentication of users based on the information from the administration manager to allow authorized users to access the golf service manager and the auxiliary service manager.

15. A method of handling golf course related information, the method comprising the steps of:
gathering and storing using an administration manager administrative information including member information;
providing golf services using a golf service manager based on the member information;
providing auxiliary services using an auxiliary service manager by linking with the golf service manager to handle golf services and auxiliary services together; and
interrelating information obtained from the administration manager, golf service manager and the auxiliary service manager.

16. The method as claimed in claim 15 wherein
the gathering and storing step use identification data to the administrative information; and
the interrelating step interrelates the information obtained from the administration manager, golf service manager and the auxiliary service manager using the identification data.

17. The method as claimed in claim 16, wherein the golf service providing step comprising the step of providing an electric tee sheet for scheduling tee time using the information from the administration manager.

18. The method as claimed in claim 17, wherein the golf service providing step comprising the step of linking the electronic tee sheet to services provided by the auxiliary service manager.

19. The method as claimed in claim 15 further comprising the step of generating reports based on the information from the administration manager, the golf service manager and the auxiliary service manager.

20. The method as claimed in claim 15 further comprising the steps of:
determining authentication of users based on information from the administration manager; and
allowing authorized users to access the golf service manager and the auxiliary service manager.

21. A computer readable memory having recorded thereon statements and instructions for execution by a computer to carry out the method of handling golf course related information, the method comprising the steps of:
gathering and storing using an administration manager administrative information including member information;
providing golf services using a golf service manager based on the member information;
providing auxiliary services using an auxiliary service manager by linking with the golf service manager to handle golf services and auxiliary services together; and
interrelating information obtained from the administration manager, golf service manager and the auxiliary service manager.

22. A carrier wave embodying a computer data signal representing sequences of statements and instructions which, when executed by a processor cause the processor to handle golf course related information, the statements and instructions comprising the steps of:
gathering and storing using an administration manager administrative information including member information;
providing golf services using a golf service manager based on the member information;
providing auxiliary services using an auxiliary service manager by linking with the golf service manager to handle golf services and auxiliary services together; and
interrelating information obtained from the administration manager, golf service manager and the auxiliary service manager.
